(19) United States
(12) Patent Application Publication
(10) Pub. No.: US 2014/0072177 A1
(43) Pub. Date: Mar. 13, 2014

(54) Methods for Identifying Vehicle License Plates

(71) Applicants: PEI-YUAN CHOU, Taipei City (TW); Shang-En Wu, Taipei City (TW); Yu-Chiang Wang, Kaohsiung City (TW)

(72) Inventors: PEI-YUAN CHOU, Taipei City (TW); Shang-En Wu, Taipei City (TW); Yu-Chiang Wang, Kaohsiung City (TW)

(21) Appl. No.: 13/612,794

(22) Filed: Sep. 12, 2012

(51) Int. Cl. G06K 9/62

(52) U.S. Cl. 382/105

(57) ABSTRACT

A method for identifying vehicle license plate, comprising: mounting a server apparatus, and establishing a vehicle database and a vehicle license plate identification library in the server apparatus so as to generate a vehicle data and a vehicle license plate identification program; establishing a communication link, and receiving the vehicle data and the vehicle license plate identification program by the mobile device, and installing the vehicle license plate identification program and storing the vehicle data; capturing plate number of a vehicle by a camera module mounted in the mobile device for generating an image and then analyzing the plate number in the image by an analyzing program to generate an analysis result; comparing the analysis result with the vehicle data by a comparison module of the mobile device for generating a comparison result; and displaying the comparison result.

### BACKGROUND OF THE INVENTION

1. Field of the Invention

The present invention relates to a method for identifying vehicle license plate, and more particularly, to a method for identifying vehicle license plate, which can immediately perform the search and report when inspecting status of a vehicle.

2. Description of the Related Art

Today, the license plate recognition is widely used in portable microcomputers, mobile phones or camcorders. Expect for applying in the parking management and passage management, the police officers also can use the license plate recognition to determine whether a car is stolen, and immediately seizure the car if the car is stolen.

However, whatever the portable microcomputers are used by the police officers or the mangers, they always manual input the plate number including numbers and characters to the portable microcomputers when inspecting the vehicle or making out the parking bill. Then, the communication module of the portable microcomputer transmits the plate number inputted to the cloud server or the remote server, and then the cloud server or the remote server identifies the plate number inputted and compare the plate number identified with the vehicle data mounted in the cloud server or the remote server; or they shoot the plate number by the cameras or camcorders to generate an image, and then transmit the image including the plate number to the portable microcomputer, and then the communication module of the portable microcomputer transmits the image to the cloud server or the remote server, and then the cloud server or the remote server identifies the plate number in the image and compare the plate number identified with the vehicle data mounted in the cloud server or the remote server. Thereby, the cloud server or the remote server generates a comparison result and returns the comparison result to the portable microcomputer after comparing, and the police officer or manager will see the status of the desired examination vehicle, for example, the stolen car or the scrapped car, etc. Nevertheless, it is inconvenient for offices to use the portable microcomputer to perform the transmission communication because the transmission communication by the communication module of the portable microcomputer must be performed under the excellent communication condition.

Moreover, dead zones also obstruct the transmission communication, for example, the cellar, the underground park, the place with many the shelters, etc. Therefore, the officers must keep away from the dead zone and search the excellent communication environment to transmit the data including the plate number to the cloud server or the remote server to perform the analysis and comparison operation, and then the cloud server or the remote server can return the comparison result to the portable microcomputer. Additionally, it is a waste of time to transmit the data including the plate number between the portable microcomputer and the server.

Accordingly, a method and system for solving the aforementioned problems is needed.

### SUMMARY OF THE INVENTION

In view of the foregoing, it is an object of the present invention to provide a method for identifying vehicle license plate, which may transmit the vehicle data and the identification program to the mobile device for installing the vehicle license plate identification program and storing the vehicle data in the mobile device.

According to one object of the present invention, the method provide by the present invention may immediately search and report results so as to prevent the interference from the dead zone and the transmission delay and increase the usage efficiency when officers, inspectors or managers perform the search operation.

According to one embodiment, a method for identifying vehicle license plate comprises: mounting a server apparatus, and establishing a vehicle database and a vehicle license plate identification library in the server apparatus so as to generate a vehicle data and a vehicle license plate identification program; establishing a communication link between the serve apparatus and a mobile device, and transmitting the vehicle data and the vehicle license plate identification program to the mobile device by a first transmission module mounted in the server apparatus, and receiving the vehicle data and the vehicle license plate identification program by a second transmission module in the mobile device, and installing the vehicle license plate identification program and storing the vehicle data in a storage module of the mobile device; performing the vehicle license plate identification program, and capturing plate number of a vehicle by a camera module mounted in the mobile device for generating an image and then analyzing the plate number in the image by an analyzing program installed in an analyzing module of the mobile device to generate an analysis result; comparing the analysis result with the vehicle data by a comparison module of the mobile device for generating a comparison result; and displaying the comparison result by a display module of the mobile device.

### BRIEF DESCRIPTION OF THE DRAWINGS

The invention, as well as its many advantages, may be further understood by the following detailed description and drawings in which:

FIG. 1 is a flow chart showing a method for identifying vehicle license plate according to one embodiment of the present invention;

FIG. 2 is configuration block diagram showing a system for identifying vehicle license plate according to one embodiment of the present invention;

FIG. 3 is the first operation schematic diagram according to the present invention;

FIG. 4 is the second operation schematic diagram according to the present invention;

FIG. 5 is the third operation schematic diagram according to the present invention; and

FIG. 6 is the fourth operation schematic diagram according to the present invention.

### DETAILED DESCRIPTION OF THE INVENTION

Reference will now be made to the drawings to describe exemplary embodiments of the present driving control system and method for visual evoked brain wave by multi-frequency phase encoder, in detail. The following description is given by way of example, and not limitation.

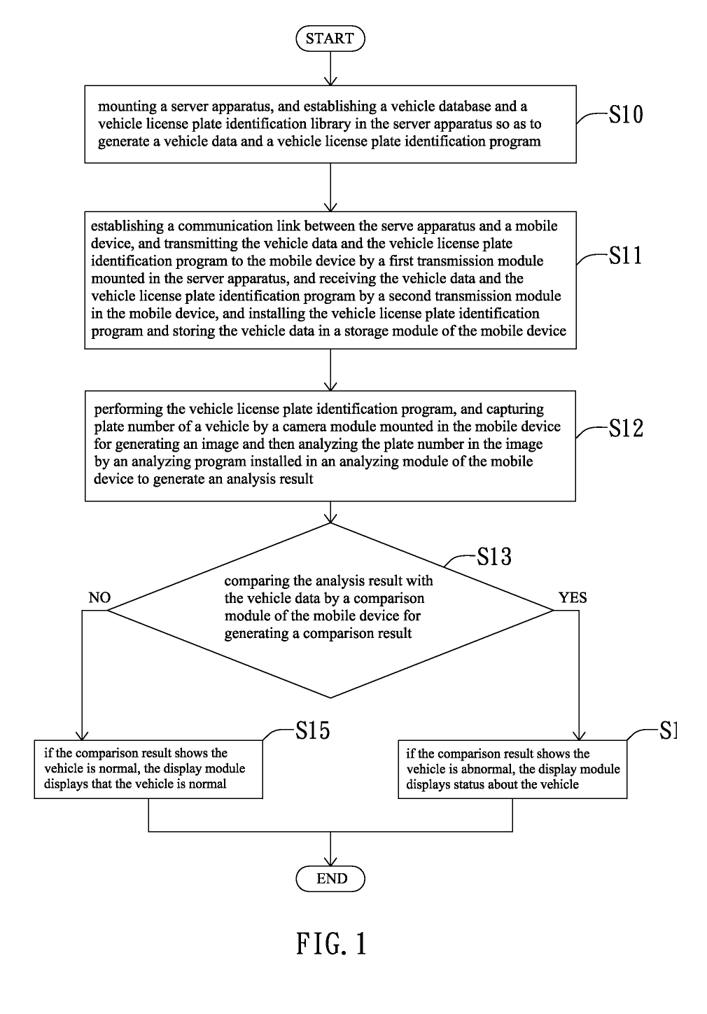

Referring to FIG. 1, which illustrates a method for identifying vehicle license plate according to one embodiment according of the present invention, and the method comprises steps as follow:

Step S10: mounting a server apparatus 10 and establishing a vehicle database 11 and a vehicle license plate identification library 12 in the server apparatus 10 so as to generate a vehicle data and a vehicle license plate identification program. Then, proceeding to Step S11.

Step S11: establishing a communication link between the server apparatus 10 and a mobile device 3, and transmitting the vehicle data and the vehicle license plate identification program to the mobile device 3 by a first transmission module 13 mounted in the server apparatus 10, and receiving the vehicle data and the vehicle license plate identification program by a second transmission module 30 in the mobile device 3, and installing the vehicle license plate identification program in the mobile device 3 and storing the vehicle data in a storage module 31 of the mobile device. Then, proceeding to Step 12.

Step S12: performing the vehicle license plate identification program, and capturing plate number 41 of a vehicle 4 by a camera module 32 mounted in the mobile device 3 for generating an image and then analyzing the plate number 41 in the image by an analyzing program installed in an analyzing module 33 of the mobile device 3 so as to generate an analysis result. Then, proceeding to Step 13.

Step S13: comparing the analysis result with the vehicle data stored in storage module 31 by a comparison module 34 of the mobile device 3 for generating a comparison result, and the comparison result shows whether the vehicle 4 with the plate number 41 is abnormal vehicle, and if the vehicle with the plate number 41 is an abnormal vehicle, proceeding to Step S14; otherwise, proceeding to Step 15.

Step S14: displaying the comparison result and the status about the vehicle 4 by a display module 35 of the mobile device 3, and the status comprises time, plate number of the vehicle, and present status of the vehicle, and the status further includes history information of the vehicle, for example, illegal and criminal records, driver's information, scrapped or maintained records.

Step S15: displaying the comparison result and noticing that the vehicle 4 is a normal vehicle by a display module 35 of the mobile device 3.

Perfectly, the analyzing program uses morphology, characterology, radiological features and the likes, to analyze the plate number 41 of the vehicle 4 in the image in the Step S12.

In the embodiment, the server apparatus 10 is selected from one of a remote server, a rear terminal server, a cloud server, a rear data update server, a remote data update server, and a cloud data update server, etc.

In the embodiment, the communication link is a wireless communication (for example, WiFi, 3.5G, etc.), and the communication link with wireless is used to transmit the vehicle data and the vehicle license plate identification program to the mobile device 3 (for example, smart phones, tablet PCs, portable microcomputers, or other mobile electronic products); the communication link is a wire communication (for example, coaxial cable, transmission line, network line, etc.), and the communication link with wire is used to transmit the vehicle data and the vehicle license plate identification program to the mobile device 3.

In the embodiment, the storage module 31 is a memory or any kind of storage card, for example, CF card, SD card, micro SD card, etc.

In the embodiment, besides the vehicle license plate identification program in the vehicle license plate identification library 12 is transmitted into the mobile device 3 via the first transmission module 13 of the server apparatus 10 and installed in the mobile device 3, the vehicle license plate identification program also can be stored in a storage medium or a storage device (for example, the optical disc (CD), the flash drive, the removable hard disk, any kind of storage card, etc.). When a computer uses a connection module (not shown) to establish a communication link between the computer and the mobile device, a reading module (not shown) of the computer reads the vehicle license plate identification program stored in the storage medium or the storage device, and transmit the vehicle license plate identification program to the mobile device so as to install the vehicle license plate identification program in the mobile device 3. Alternatively, the vehicle license plate identification program stored in the storage medium or the storage device may immediately connect to the mobile device 3 to install the vehicle license plate identification program in the mobile device 3.

Moreover, the method for identifying vehicle license plate in the embodiment uses the camera module 32 of the mobile device 3 to capture the plate number 41 of the vehicle 4 so as to generate the image, and the analyzing module 33 of the mobile device 3 analyzes the plate number 41 in the image to generate an analysis result. Afterward, the comparison module 34 of the mobile device 3 compares the analysis result with the vehicle data stored in the storage module 31 so as to generate the comparison result. Lastly, the display module 35 of the mobile device 3 displays the comparison result for allowing the officers to search the status about the vehicle immediately, for example, the stolen car, the scrapped car, the car for illegal activities, etc.

Specifically, if the vehicle data in the vehicle database 11 of the server apparatus 10 is updated, the vehicle data updated may be transmitted to the mobile device 3 via the communication link between the server apparatus 10 and the mobile device 3 to update the vehicle data stored in the storage module 31 of the mobile device 3 so as to maintain the vehicle data up to date; or the updated vehicle data is stored in the storage medium or the storage device (for example, the optical disc (CD), the flash drive, the removable hard disk, any kind of storage card, etc.), and the reading module (not shown) of the computer reads the updated vehicle data stored in the storage medium or the storage device, and transmit the updated vehicle data to the mobile device so as to update the vehicle data in the mobile device 3. Alternatively, the updated vehicle data stored in the storage medium or the storage device may immediately connect to the mobile device 3 to update the vehicle data in the mobile device 3.

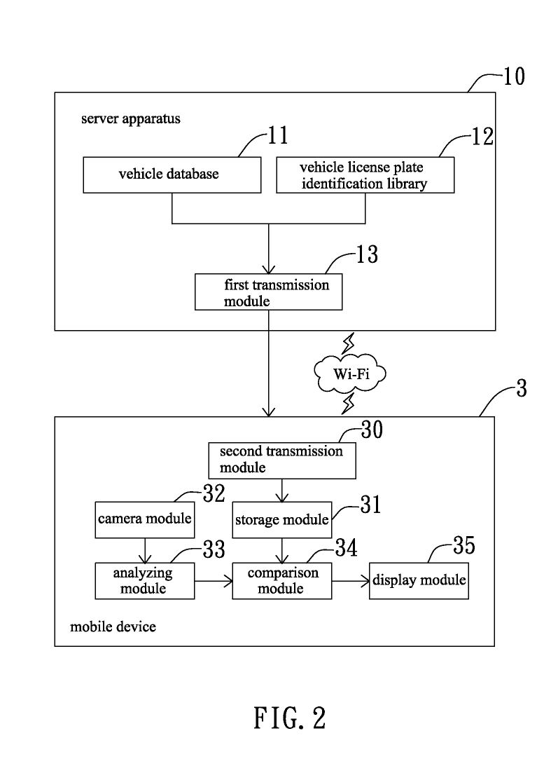

Referring to FIG. 2, which illustrates a system for identifying vehicle license plate according to one embodiment of the present invention, and the system comprises; a server apparatus 10 and a mobile device 3, and the server apparatus 10 further comprises a vehicle database 11 storing a vehicle data, a vehicle license plate identification library 12 storing a vehicle license plate identification program and a first transmission module 13, and the mobile device 3 further comprises a second transmission module 30, a storage module 31, a camera module 32, an analyzing module 33, a comparison module 34 and a display module 35.

A communication link is established between the server apparatus 10 and the mobile device 3 by the first transmission module 13 of the server apparatus 10 and the second transmission module 30 of the mobile device 3, and the vehicle data and the vehicle license plate identification program are transmitted out by the first transmission module 13 and the second transmission module 30 receives the vehicle data and the vehicle license plate identification program, and the vehicle data received is stored in the storage module 31 and the vehicle license plate identification program is installed in the mobile device 3.

The camera module 32 captures the plate number 41 of the vehicle 4 to generate an image, and the analyzing module 33 receives the image and analyzes the plate number in the image to generate an analysis result, and the comparison module 34 receives the analysis result and compares the analysis result with the vehicle data stored in the storage module 31 to generate an comparison result, and the display module 35 receives the comparison result and displays the comparison result.

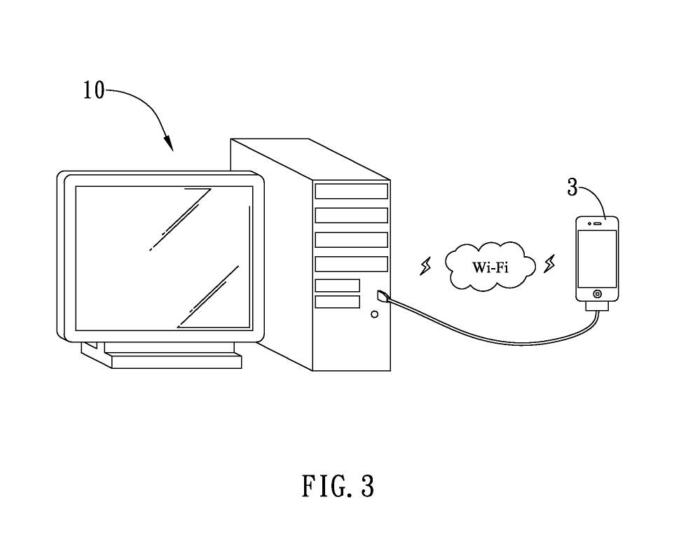

Referring to FIG. 3 through FIG. 6, the operation schematic diagrams are provided by the present invention. As shown in FIG. 3, the police officer, the traffic inspector or the manager applies the mobile device 3 (for example, smart phones, tablet PCs, portable microcomputers, or other mobile electronic products) to establish a communication link between the second transmission module 30 of the mobile device 3 and the first transmission module 13 of the server apparatus 10, and the communication link is one of wireless communication (for example, WiFi, 3.5G, etc.) and wire communication (for example, coaxial cable, transmission line, network line, etc.). Thereby, the vehicle data stored in the vehicle database and the vehicle license plate identification program stored in the vehicle license plate identification library 12 are transmitted into the mobile device 3, and the vehicle license plate identification program may be installed in the mobile device 3 automatically or manually, and the vehicle data is stored in the storage module 31.

Furthermore, besides the vehicle license plate identification program in the vehicle license plate identification library 12 is transmitted into the mobile device 3 via the first transmission module 13 of the server apparatus 10 and installed in the mobile device 3, the vehicle license plate identification program also can be stored in a storage medium or a storage device (for example, the optical disc (CD), the flash drive, the removable hard disk, any kind of storage card, etc.). When a computer or the server apertures 10 uses a connection module (not shown) to establish a communication link between the computer and the mobile device, a reading module (not shown) of the computer or the server apertures 10 reads the vehicle license plate identification program stored in the storage medium or the storage device, and transmit the vehicle license plate identification program to the mobile device so as to install the vehicle license plate identification program in the mobile device 3. Alternatively, the vehicle license plate identification program stored in the storage medium or the storage device may immediately connect to the mobile device 3 to install the vehicle license plate identification program in the mobile device 3.

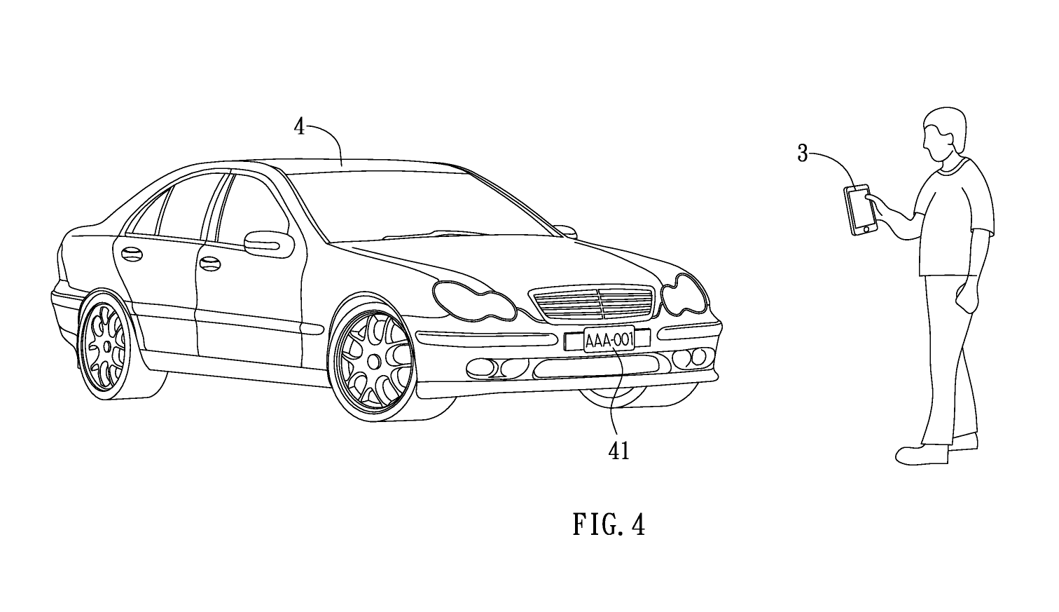

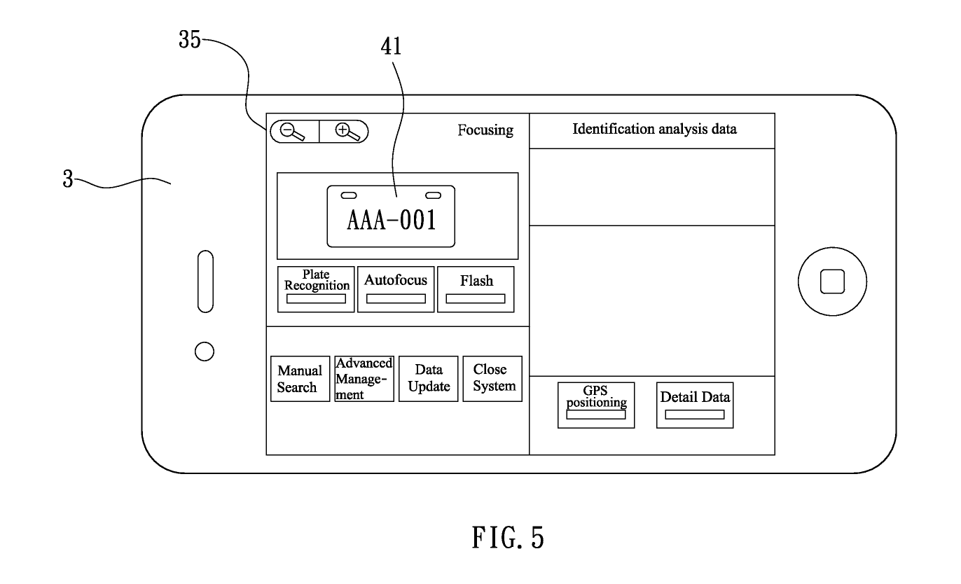

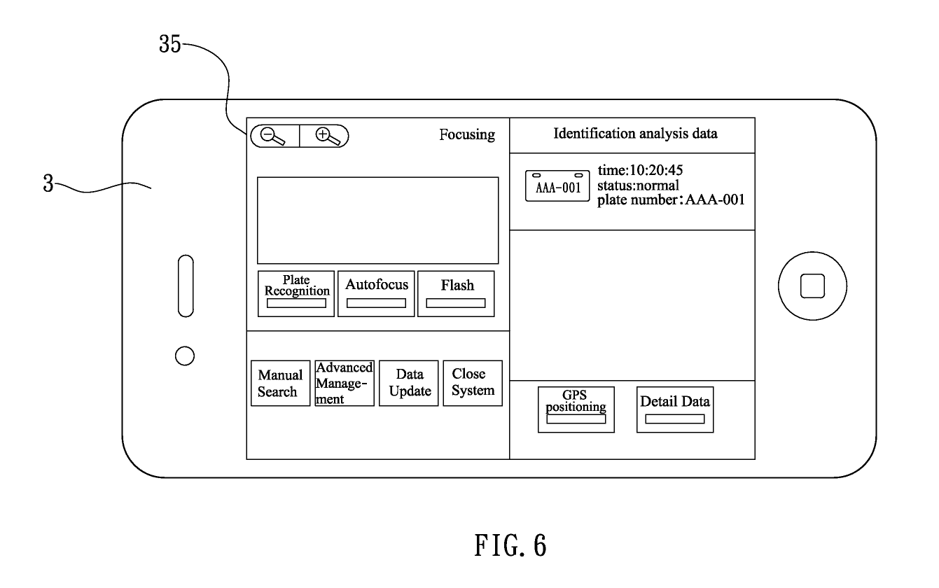

As shown in FIG. 4, When the police officer, the traffic inspector or the manager performs the vehicle examination, the vehicle information for violating traffic regulations or the vehicle bill information for parking, and searches the status of the vehicle 4, the vehicle license plate identification program in the mobile device 3 is firstly operated and the camera module 32 of the mobile device 3 captures the plate number 41 (for example, AAA-001) of the vehicle 4 to generate an image. As shown in FIG. 5, the image including the plate number 41 (for example, AAA-001) on the mobile device 3 is analyzed by the analyzing module 33 to generate an analysis result, and the comparison module 34 compares the analysis result with the vehicle data stored in the storage module 31 for determining whether the vehicle is abnormal so as to generate an comparison result, and the display module 35 display the comparison result. If the comparison result shows the vehicle 4 with the plate number 41 is abnormal, the mobile device 3 will display the status about the vehicle 4 by a display module 35 of the mobile device 3, for example, the stolen car, the scrapped car, the car for illegal activities, etc.; otherwise, the mobile device 3 will notice that the vehicle 4 is a normal vehicle by a display module 35 of the mobile device 3, as shown in FIG. 6. In addition, the analyzing program uses morphology and characterology to analyze the plate number 41 in the image. Additionally, as shown in FIGS. 5 and 6, the present invention displays some operation buttons on the mobile device 3, and the officer, the inspector or manager may apply these operation buttons to capture the plate number of the vehicle, analyze the plate number, and etc. For example, the buttons of “Autofocus” and “Flash” are used to capture the plate number, the button of “Plate Recognition” is used to analyzing the plate number, the buttons of “Manual Search”, “Advanced Management”, “Data Update”, “Close System”, “GPS positioning”, “Detail Data” and “Identification analysis data” are used to manage the system, update the data stored in the system, search the status about the vehicle, and display the status of the vehicle, etc.

Specifically, when the vehicle data stored in the vehicle data 11 of the server apparatus 10 is updated, the police officer, the traffic inspector or the manager may establish the communication link between the server apparatus 10 and the mobile device 3, and then the vehicle data updated may be transmitted to the mobile device 3 via the communication link between the server apparatus 10 and the mobile device 3 to update the vehicle data stored in the storage module 31 of the mobile device 3 so as to maintain the vehicle data up to date; or the updated vehicle data is stored in the storage medium or the storage device (for example, the optical disc (CD), the flash drive, the removable hard disk, etc.), and the reading module (not shown) of the computer reads the updated vehicle data stored in the storage medium or the storage device, and transmit the updated vehicle data to the mobile device so as to update the vehicle data in the mobile device 3. Alternatively, the updated vehicle data stored in the storage medium or the storage device may immediately connect to the mobile device 3 to update the vehicle data in the mobile device 3.

In the embodiment, the police officer, the traffic inspector or the manager may use the system for identifying vehicle license plate of the present invention to immediately search and report the status of the vehicle (for example, cars or motorcycles). The plate number 41 captured by the camera module 32 is not returned to the server apparatus 10 (for example, a remote server, a rear terminal server, a cloud server, a rear data update server, a remote data update server, and a cloud data update server, etc.) to perform a comparison process. In other words, when the image including the plate number captured by the camera module 32 is transmitted to the server apparatus 10 by the second transmission 30 of the mobile device 3, the dead zone will obstruct and delay the transmission. In this way, it not only gives the criminals and thieves enough time to remove the crime evidence or transfer the vehicle for illegal activities to other safety places to avoid the search, report, and capture from the police officer, the traffic inspector or the manager, but also makes troubles for the police officer, the traffic inspector or the manager and easily cause serious safe problems.

Therefore, the police officer, the traffic inspector or the manager may use the method for identifying vehicle license plate of the present invention to search and report the status of the vehicle immediately, and the image including the plate number 41 captured by the camera module is not returned to the server apparatus 10 (for example, a remote server, a rear terminal server, a cloud server, a rear data update server, a remote data update server, and a cloud data update server, etc.) to perform a comparison process so as to achieve the purpose of immediately searching and reporting.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A method for identifying vehicle license plate, comprising:
mounting a server apparatus, and establishing a vehicle database and a vehicle license plate identification library in the server apparatus so as to generate a vehicle data and a vehicle license plate identification program;
establishing a communication link between the serve apparatus and a mobile device, and transmitting the vehicle data and the vehicle license plate identification program to the mobile device by a first transmission module mounted in the server apparatus, and receiving the vehicle data and the vehicle license plate identification program by a second transmission module in the mobile device, and installing the vehicle license plate identification program and storing the vehicle data in a storage module of the mobile device;
performing the vehicle license plate identification program, and capturing plate number of a vehicle by a camera module mounted in the mobile device for generating an image and then analyzing the plate number in the image by an analyzing program installed in an analyzing module of the mobile device to generate an analysis result;
comparing the analysis result with the vehicle data by a comparison module of the mobile device for generating a comparison result; and
displaying the comparison result by a display module of the mobile device.

2. The method as claimed in claim 1, wherein the analyzing program uses morphology and characterology to analyze the plate number in the image.

3. The method as claimed in claim 1, wherein the communication link is one of wireless communication and wire communication, and the communication link is used to transmit the data for transmitting the vehicle data and the vehicle license plate identification program to the mobile device.

4. The method as claimed in claim 1, wherein the step of installing the vehicle license plate identification program further comprises:
storing the vehicle data and the vehicle license plate identification program in one of a storage medium and a storage device;
establishing the communication link between a computer and the mobile device;
reading the vehicle license plate identification program by a reading module of the computer, and transmitting the vehicle license plate identification program to the mobile device; and
installing the vehicle license plate identification program in the mobile device.
